(19) United States
(12) Patent Application Publication
(10) Pub. No.: US 2004/0124256 A1
(43) Pub. Date: Jul. 1, 2004

(54) High-velocity flame spray gun and spray method using the same

(76) Inventors: Tsuyoshi Itsukaichi, Aichi (JP); Satoru Osawa, Aichi (JP); Tohru Morishita, Tokyo (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/682,161

(22) Filed: Oct. 9, 2003

(30) Foreign Application Priority Data
Oct. 11, 2002 (JP) 2002-299527

(51) Int. Cl. B05B 1/24

(52) U.S. Cl. 239/79; 239/433; 239/85

(57) ABSTRACT

A thermal spray gun of the present invention is capable of forming a good-quality ceramic spray coating. According to the machine, a flame generated in a combustion chamber of the machine is sent into a passage formed from the combustion chamber and through a discharge port that communicates with the combustion chamber, and then the flame is discharged from the discharge port to outside of the machine. A spray material is fed to the flame passing through the passage so that the spray material can be softened or melted by the flame and can be jetted out. An auxiliary fuel is fed to the flame passing through the passage to increase a temperature of the flame.

### BACKGROUND OF THE INVENTION

The present invention relates to a thermal spray gun for ceramic spraying, and a thermal spray method using the same.

In a high-velocity flame spray method, a flame generated by combustion of a fuel and oxygen, or by combustion of a fuel and air is used as a heat source for thermal spraying. A flame temperature in the high-velocity flame spray method is relatively low. Therefore, as described in Japanese Laid-Open Patent Publication No. 10-60617 and Japanese Laid-Open Patent Publication No. 11-222662, it is difficult to thermally spray ceramics having high melting point by the high-velocity flame spray method.

In a plasma spray method, a plasma flame is used as a heat source for thermal spraying. A plasma flame temperature in the plasma spray method is relatively high. As described in Japanese Laid-Open Patent Publication No. 5-339699, the plasma spray method has generally been used as a method for spraying ceramics.

However, a dense spray coating cannot be obtained by the plasma spray method. This is because a flying speed of spray particles is not so high in the plasma spray method. Thus, the spray coating obtained by spraying ceramics in the plasma spray method is inferior to a ceramic sintered product in various characteristics, such as wear resistance.

### SUMMARY OF THE INVENTION

Accordingly, it is an objective of the present invention to provide a thermal spray gun capable of forming a good-quality ceramic coating, and a thermal spray method using the same.

To achieve the above objective, the present invention provides a thermal spray gun, which includes a combustion chamber, a spray material feed section, a passage, a discharge port, and an auxiliary fuel feed section. The combustion chamber is for generating a flame. The spray material feed section, which communicates with the combustion chamber, is for feeding a spray material to the flame so that the spray material can be softened or melted by the flame. The discharge port, which communicates with the combustion chamber, is for discharging the flame to outside of the thermal spray gun and is for jetting out the spray material softened or melted by the flame. The passage is formed from the combustion chamber and through the discharge port. The auxiliary fuel feed section, which is disposed in said passage, is for feeding an auxiliary fuel to the flame passing through the passage so as to elevate a temperature of the flame.

The present invention also provides a thermal spray method using a thermal spray gun. The thermal spray method includes a step of generating a flame in a combustion chamber disposed in the thermal spray gun, the generated flame being sent into a passage formed from the combustion chamber and through a discharge port that communicates with the combustion chamber, wherein the flame is then discharged from the discharge port to outside of the thermal spray gun; a step of feeding a spray material to the flame passing through the passage so that the spray material can be softened or melted by the flame and can be jetted out; and a step of feeding an auxiliary fuel to the flame passing through the passage to increase a temperature of the flame.

Other aspects and advantages of the invention will become apparent from the following description, taken in conjunction with the accompanying drawings, illustrating by way of example the principles of the invention.

### BRIEF DESCRIPTION OF THE DRAWING

The invention, together with objects and advantages thereof, may best be understood by reference to the following description of the presently preferred embodiments together with the accompanying drawings, in which:

FIG. 1 is a cross-sectional view of a high-velocity flame spray gun according to an embodiment of the present invention.

### DETAILED DESCRIPTION OF THE PREFERRED EMBODIMENTS

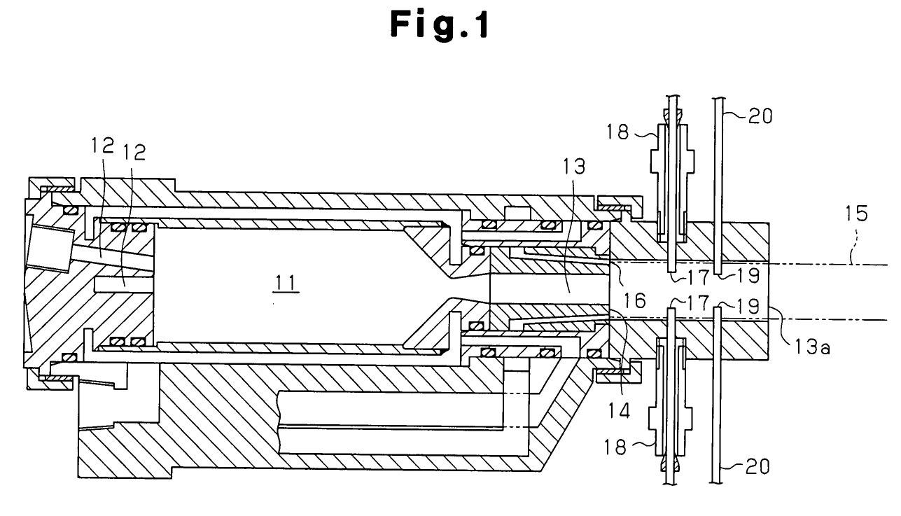

An embodiment of the present invention will now be described with referring to FIG. 1.

A high-velocity flame spray gun according to the embodiment shown in FIG. 1 burns a fuel and oxygen to generate a flame of a high temperature and high pressure, so that a spray material is softened or melted by the flame and the softened or melted material is sprayed from the spray gun. The spray gun comprises a combustion chamber 11 in which the fuel and the oxygen are burned. A first passage 12, which communicates with the combustion chamber 11 and which opens to the outside at a rear end (left end in FIG. 1) of the spray gun, introduces the fuel and the oxygen into the combustion chamber 11. A second passage 13, which communicates with the combustion chamber 11 and which opens to the outside at a front end (right end in FIG. 1) of the spray gun, discharges the flame generated by burning the fuel and the oxygen in the combustion chamber 11 to the outside. The flame flows through the second passage 13 and is discharged through a discharge port 13a at the front end (right end in FIG. 1) of the second passage 13.

On the midway of the second passage 13, a step surface 14 is disposed to be directed to the discharge port 13a. Spray ports 16 are disposed on the step surface 14 to spray a cylindrical airflow 15 to the discharge port 13a. The flame flowing through the second passage 13 to the discharge port 13a passes through the inside of the cylindrical airflow 15 sprayed from the spray ports 16.

A pair of spray material feed sections 17 is disposed on the portion of the second passage 13 between the step surface 14 and the discharge port 13a. Each spray material feed section 17 is a port on the downstream end of a connecting pipe 18 extended from an unillustrated spray material feeder. The spray material feed sections 17 feed a spray material to the flame that flows through the inside of the cylindrical airflow 15. Thus, the spray material fed from the spray material feed sections 17 is softened or melted by the flame in the cylindrical airflow 15, and the thus softened or melted material is jetted out.

A pair of auxiliary fuel feed sections 19 is disposed on the portion of the second passage 13 between the spray material feed sections 17 and the discharge port 13a. The auxiliary fuel feed section 19 is a port on the downstream end of a connecting pipe 20 extended from an unillustrated auxiliary fuel feeder. The auxiliary fuel feed section 19 feeds an auxiliary fuel to the flame which flows through the inside of the cylindrical airflow 15.

There is no particular limitation on the auxiliary fuel, and for example, acetylene, propane, propylene etc., may be used. The preferred auxiliary fuel is acetylene because it generates a large amount of heat. A distance between the thermal spray material feed section 17 and the auxiliary fuel feed section 19 is preferably within 25 mm. A feeding speed of the auxiliary fuel is preferably at least 10 L/min.

In the case of carrying out spraying under the following conditions by using the spray gun shown in FIG. 1, a temperature of the flame is at least 2500° C., and a speed of the flame which passes through the discharge port 13a is at least 1000 m/sec.

Oxygen flow rate: 1900 scfh (893 mL/min)

Fuel (kerosene) flow rate: 5.1 gph (0.32 L/min)

Inner diameter of connecting pipe 20: 2 mm

Auxiliary fuel flow rate: 30 L/min

In contrast, in the case of carrying out spraying under the following conditions by using the conventional high-velocity flame spray gun, a temperature of the flame is in the range of 1600 to 1800° C., which is lower compared with that of the flame in a case where the spray gun shown in FIG. 1 is used.

Oxygen flow rate: 1900 scfh (893 mL/min)

Kerosene flow rate: 5.1 gph (0.32 L/min)

In the case of carrying out spraying under the following conditions by using a plasma spray gun “SG-100” of PRAXAIR Corp, a speed of a plasma flame is in the range of 500 to 600 m/sec, which is lower compared with that of the flame in the case where the spray gun shown in FIG. 1 is used.

Argon gas pressure: 65 psi (45 MPa)

Helium gas pressure: 100 psi (69 MPa)

Next, description will be made of a method for spraying ceramics by using the spray gun shown in FIG. 1.

The spray material fed to the flame from the spray material feed section 17 is preferably ceramic powder. Specific examples of useful ceramic powders are alumina, titania, zirconia, chromia, magnesia, cobalt oxide, and yttria powder; and mullite, cordierite, and spinel powders, which are complex compounds thereof. The spray material may be a mixture of different kinds of ceramic powders.

If the spray material is a ceramic powder, preferably a 50th percentile diameter D_{50%} (defined below) of the ceramic powder is at least 0.1 μm, more preferably at least 0.5 μm, and most preferably at least 1 μm. The 50th percentile diameter D_{50%} of the ceramic powder is preferably no more than 25 μm, more preferably no more than 15 μm, and most preferably no more than 5 μm. A value obtained by subtracting a 10th percentile diameter D_{10%} (defined below) of the ceramic powder from a 90th percentile diameter D_{90%} (also defined below) of the ceramic powder, and dividing it by the 50th percentile diameter D_{50%} of the ceramic powder is preferably no more than 5.0, more preferably no more than 2.5, and most preferably no more than 1.5.

The 50th percentile diameter D_{50%} is the diameter of a ceramic particle contained in the ceramic powder, lastly integrated in integrating the volume of each ceramic particle contained in the ceramic powder in ascending order until the integrated value reaches 50% of the total of the volumes of all the ceramic particles contained in the ceramic powder. In other words, it is the diameter of a ceramic particle below which 50% (by volume) of the all particles contained in the ceramic powder are smaller.

The 10th percentile diameter D_{10%} is the diameter of a ceramic particle contained in the ceramic powder, lastly integrated in integrating the volume of each ceramic particle contained in the ceramic powder in ascending order until the integrated value reaches 10% of the total of the volumes of all the ceramic particles contained in the ceramic powder. In other words, it is the diameter of a ceramic particle below which 10% (by volume) of the all particles contained in the ceramic powder are smaller.

The 90th percentile diameter D_{90%} is the diameter of a ceramic particle contained in the ceramic powder, lastly integrated in integrating the volume of each ceramic particle contained in the ceramic powder in ascending order until the integrated value reaches 90% of the total of the volumes of all the ceramic particles contained in the ceramic powder. In other words, it is the diameter of a ceramic particle below which 90% (by volume) of the all particles contained in the ceramic powder are smaller.

The 50th percentile diameter D_{50%}, the 10th percentile diameter D_{10%}, and the 90th percentile diameter D_{90%} are obtained from particle size measurement data of the ceramic powder measured by a laser diffraction method.

This embodiment of the present invention provides the following advantages.

According to the spray gun shown in FIG. 1, since the auxiliary fuel is fed to the flame, the temperature of the flame is higher than that in the case of the conventional spray gun. Thus, the spray gun shown in FIG. 1 can satisfactorily spray even a spray material of a high melting point, such as ceramics that have been difficult to be sprayed by the conventional spray gun.

The spray coating formed by ceramic spraying that uses the spray gun shown in FIG. 1 has characteristics close to those of a ceramic sintered product, especially good wear resistance, compared with the spray coating formed by ceramic spraying that uses the conventional plasma spray gun. The high-velocity flame spray gun jets out the melted or softened spray material at a relatively high speed, and deposits the spray material on the substrate by a high collision force. Thus, the spray coating formed by using the high-velocity flame spray gun is dense. Because of this dense formation, wear resistance is expected to be high.

According to the spray gun shown in FIG. 1, the spray material is fed to the flame, which flows through the inside of the cylindrical airflow 15 toward the discharge port 13a. Thus, the spray material is softened or melted by the flame in the cylindrical airflow 15, and is then jetted out. Thus, adhesion or deposition of the softened or melted spray material on the inner surface of the second passage 13 is suppressed. When the spray material deposited on the inner surface of the second passage 13 falls off to be mixed in the spray coating, the quality of the spray coating is reduced. A phenomenon of mixing of the deposited spray material in the spray coating is called spitting. Since spitting generally occurs more easily as a temperature of the flame becomes higher, it is normally considered that spitting tends to occur in the spray gun shown in FIG. 1, in which the temperature of the flame is high compared with the conventional high-velocity flame spray gun. However, in the spray gun shown in FIG. 1, the occurrence of spitting is suppressed because of the aforementioned constitution, in which the spray material is softened or melted in the cylindrical airflow 15 and the softened or melted material is then jetted out.

In the spray gun shown in FIG. 1, the auxiliary fuel feed section 19 is disposed on the portion of the second passage 13 between the spray material feed sections 17 and the discharge port 13a. Thus, the spray material fed from the spray material feed section 17 is surely softened or melted by the flame set to a high temperature by the auxiliary fuel fed from the auxiliary fuel feed section 19.

If a distance between the spray material feed section 17 and the auxiliary fuel feed section 19 is within 25 mm, the spray material is effectively softened or melted by the flame set to a high temperature by the auxiliary fuel. Conversely, if the distance between the spray material feed section 17 and the auxiliary fuel feed section 19 exceeds 25 mm, the spray material may not be properly fed to the flame. The spray material not fed properly to the flame is jetted out without sufficiently melted or softened. Thus, the quality of the spray coating is reduced.

If the ceramic powder, in which a 50th percentile diameter D_{50%} is at least 0.1 μm, is sprayed by using the spray gun shown in FIG. 1, a dense ceramic spray coating of high wear resistance can be obtained more surely. If the 50th percentile diameter D_{50%} of the ceramic powder is at least 0.5 μm, the aforementioned effects can be enhanced, and enhanced further more if it is at least 1 μm. On the other hand, when the ceramic powder, in which a 50th percentile diameter D_{50%} is excessively small, is sprayed, it is not properly fed to the flame, and consequently formation of a spray coating becomes difficult.

If the ceramic powder, in which a 50th percentile diameter D_{50%} is no more than 25 μm, is sprayed by using the spray gun shown in FIG. 1, a dense ceramic spray coating of high wear resistance can be obtained more surely. If the 50th percentile diameter D_{50%} of the ceramic powder is no more than 15 μm, the aforementioned effects can be enhanced, and enhanced further more if it is no more than 5 μm. On the other hand, when the ceramic powder, in which a 50th percentile diameter D_{50%} is excessively large, is sprayed, it is not easily melted or softened, and consequently formation of a spray coating becomes difficult.

If the ceramic powder, in which a value obtained by subtracting a 10th percentile diameter D_{10%} from a 90th percentile diameter D_{90%} and dividing it by a 50th percentile diameter D_{50%} is no more than 5.0, is sprayed by using the spray gun shown in FIG. 1, a dense ceramic spray coating of high wear resistance can be obtained more surely. If the value of the ceramic powder is no more than 2.5, the aforementioned effects can be enhanced, and enhanced further more if it is no more than 1.5. On the other hand, when the ceramic powder, in which the value is excessively large, is sprayed, it is not properly fed to the flame, not easily melted or softened, and consequently formation of a spray coating becomes difficult.

It should be apparent to those skilled in the art that the present invention may be embodied in many other specific forms without departing from the spirit or scope of the invention. Particularly, it should be understood that the invention may be embodied in the following forms.

The auxiliary fuel feed section 19 may be disposed on the portion of the second passage 13 between the combustion chamber 11 and the step surface 14 in place of the portion of the second passage 13 between the step surface 14 and the discharge port 13a.

The auxiliary fuel feed section 19 may be disposed on the portion of the second passage 13 between the combustion chamber 11 and the spray material feed section 17 in place of the portion of the second passage 13 between the spray material feed section 17 and the discharge port 13a. Alternatively, the auxiliary fuel feed section 19 may be disposed on the portion of the second passage 13 between the combustion chamber 11 and the spray material feed section 17 in addition to the portion of the second passage 13 between the spray material feed section 17 and the discharge port 13a.

The spray ports 16 may be omitted.

The number of spray material feed sections 17 may be one, three, or more.

The number of auxiliary fuel feed sections 19 may be one, three, or more.

The oxygen fed through the first passage 12 to the combustion chamber may be replaced by air. That is, the spray gun shown in FIG. 1 may soften or melt the spray material by a flame of a high temperature and high pressure generated by combustion of the fuel and air instead of the combustion of the fuel and oxygen, and may jet out the softened or melted material.

The spray gun shown in FIG. 1 may also be used when a spray material other than ceramic powders is sprayed.

Next, the present invention will be described more specifically by way of examples and comparative examples.

In each of Examples 1 to 36 and Comparative Examples 1 to 6, ceramic powders are sprayed on a substrate made of an SS400 steel plate in order to form a ceramic spray coating of a thickness 100 μm. Details on spray guns and ceramic powders used in the examples and comparative examples are as shown in Tables 1 and 2.

In each example, a thickness of a coating sprayed formed per path was measured. A thickness of at least 10 μm was evaluated to be ⊚, a thickness of at least 7 μm to less than 10 μm was evaluated to be ◯, a thickness of at least 5 μm to less than 7 μm was evaluated to be Δ, a thickness of at least 3 μm to less than 5 μm was evaluated to be ▴, and a thickness of less than 3 μm was evaluated to be X. The results are shown in “deposit efficiency” sections of Tables 1 and 2.

In order to evaluate wear resistance of the spray coating obtained in each example, the spray coating was subjected to a wear test compliant with JIS H8682-1. That is, by using SUGA wear tester, the surface of the spray coating was rubbed by polishing paper (SiC#240) at a load of 2 kg. A wear volume less than 0.4 time of a wear volume when a similar test was conducted by an SS400 steel plate was evaluated to be ⊚, a wear volume of at least 0.4 time to less than 0.6 time was evaluated to be ◯, a wear volume of at least 0.6 time to less than 0.8 time was evaluated to be Δ, a wear volume of at least 0.8 time to less than 1.0 time was evaluated to be ▴, and a wear volume of at least 1.0 time was evaluated to be X. The results are shown in “wear resistance” columns of Tables 1 and 2.

In order to evaluate a density of the spray coating obtained in each example, porosity of a section of the spray coating was measured by using an image analysis processing device “NSFJ1-A” by N-Support Corp. Measured porosity of less than 3% was evaluated to be ⊚, porosity of at least 3% to less than 5% was evaluated to be ◯, porosity of at least 5% to less than 7% was evaluated to be Δ, porosity of at least 7% to less than 10% was evaluated to be ▴, and porosity of at least 10% was evaluated to be X. The results are shown in “density” columns of Tables 1 and 2.

The values of the 50th percentile diameter D_{50%}, the 90th percentile diameter D_{90%}, and the 10th percentile diameter D_{10%} of the ceramic powders in Tables 1 and 2 were measured by using a laser diffraction/scattering particle diameter measuring device “LA-300” by Horiba, Ltd. A numerical value shown in the columns of “position of auxiliary fuel feed section” indicates a distance between the spray material feed section and the auxiliary fuel feed section. A case in which the auxiliary fuel feed section rather than the spray material feed section is located on the downstream side of the second passage is represented by a positive value. A case in which the auxiliary fuel feed section rather than the spray material feed section is located on the upstream side of the second passage is represented by a negative value. In the column of “spray machine type”, “A” denotes a spray machine in which two auxiliary fuel feed sections are disposed in a high-velocity flame spray machine “θ-Gun” by WHITCO JAPAN, “B” denotes a high-velocity flame spray machine “θ-Gun” by WHITCO Japan, “C” denotes a high-velocity flame spray machine “JP-5000” by PPAXAIR/TAFA Corp, and “D” denotes a plasma spray machine “SG-100” by PRAXAIR Corp. These spray machines are used under the following conditions.

“θ-Gun” equipped with the auxiliary fuel feed sections

Oxygen flow rate: 1900 scfh (893 mL/min)

Kerosene flow rate: 5.1 gph (0.32 L/min)

Inner diameter of connecting pipe of auxiliary fuel feed section: 2 mm

Spraying distance: 150 mm p0 Moving speed of spray gun: 750 mm

Pitch width: 6.0 mm

Amount of ceramic powder fed: 30 g/min

“θ-Gun”

Oxygen flow rate: 1900 scfh (893 mL/min)

Kerosene flow rate: 5.1 gph (0.32 L/min)

Spraying distance: 150 mm

Moving speed of spray gun: 750 mm

Pitch width: 6.0 mm

Amount of ceramic powder fed: 30 g/min

“JP-5000”

Oxygen flow rate: 1900 scfh (893 mL/min)

Kerosene flow rate: 5.1 gph (0.32 L/min)

Spraying distance: 380 mm

Nozzle length: 4 inches (about 100 mm)

Moving speed of spray gun: 750 mm

Pitch width: 6.0 mm

Amount of ceramic powder fed: 30 g/min

“SG-100”

Argon gas pressure: 65 psi (45 MPa)

Helium gas pressure: 100 psi (69 MPa)

Spraying distance: 100 mm

Moving speed of spray gun: 750 mm

Pitch width: 6.0 mm

Amount of ceramic powder fed: 30 g/min

TABLE 1

| | Spray machine | | | | | | | | |
|---|---|---|---|---|---|---|---|---|---|
| | | | | Position | | | | | |
| | | | Flow | of | | | | | |
| | | | rate of | auxiliary | Ceramic powder | | | | |
| | Spray | Kind of | auxiliary | fuel feed | (white alumina) | | | | |
| | machine | auxiliary | fuel | section | D_{50%} | | Deposit | Wear | |
| | type | fuel | (l/min) | (mm) | (μm) | (D_{90%} − D_{10%})/D_{50%} | efficiency | resistance | Density |
| Example 1 | A | Acetylene | 30 | 10 | 2.0 | 1.4 | ⊚ | ⊚ | ⊚ |
| Example 2 | A | Propane | 30 | 10 | 2.0 | 1.4 | ◯ | ⊚ | ⊚ |
| Example 3 | A | Propylene | 30 | 10 | 2.0 | 1.4 | ◯ | ⊚ | ⊚ |
| Example 4 | A | Acetylene | 15 | 10 | 2.0 | 1.4 | ◯ | ⊚ | ⊚ |
| Example 5 | A | Acetylene | 5 | 10 | 2.0 | 1.4 | Δ | ⊚ | ⊚ |
| Example 6 | A | Acetylene | 30 | 0 | 2.0 | 1.4 | ◯ | ⊚ | ⊚ |
| Example 7 | A | Acetylene | 30 | −10 | 2.0 | 1.4 | Δ | ◯ | ◯ |
| Example 8 | A | Acetylene | 30 | 20 | 2.0 | 1.4 | ◯ | ⊚ | ⊚ |
| Example 9 | A | Acetylene | 30 | 30 | 2.0 | 1.4 | Δ | ◯ | ◯ |
| Example 10 | A | Acetylene | 30 | 10 | 0.8 | 1.4 | ◯ | ⊚ | ⊚ |
| Example 11 | A | Acetylene | 30 | 10 | 0.3 | 1.4 | Δ | ⊚ | ⊚ |
| Example 12 | A | Acetylene | 30 | 10 | 0.08 | 1.4 | ▾ | ⊚ | ⊚ |
| Example 13 | A | Acetylene | 30 | 10 | 7 | 1.4 | ◯ | ◯ | ◯ |
| Example 14 | A | Acetylene | 30 | 10 | 18 | 1.4 | Δ | Δ | Δ |
| Example 15 | A | Acetylene | 30 | 10 | 28 | 1.4 | ▾ | ▾ | ▾ |
| Example 16 | A | Acetylene | 30 | 10 | 2.0 | 2.1 | ◯ | ⊚ | ⊚ |
| Example 17 | A | Acetylene | 30 | 10 | 2.0 | 3.0 | Δ | ⊚ | ⊚ |
| Example 18 | A | Acetylene | 30 | 10 | 2.0 | 6.1 | ▾ | ⊚ | ⊚ |
| Comparative | B | None | — | — | 2.0 | 1.4 | X | — | — |
| Example 1 | | | | | | | | | |
| Comparative | C | None | — | — | 2.0 | 1.4 | X | — | — |
| Example 2 | | | | | | | | | |
| Comparative | D | None | — | — | 1.9 | 1.3 | ⊚ | X | X |
| Example 3 | | | | | | | | | |

TABLE 2

| | Spray machine | | | | | | | | |
|---|---|---|---|---|---|---|---|---|---|
| | | | | Position | | | | | |
| | | | Flow | of | Ceramic powder | | | | |
| | | | rate of | auxiliary | (Al₂O₃— | | | | |
| | Spray | Kind of | auxiliary | fuel feed | 10%Co₃O₄) | | | | |
| | machine | auxiliary | fuel | section | D_{50%} | | Deposit | Wear | |
| | type | fuel | (l/min) | (mm) | (μm) | (D_{90%} − D_{10%})/D_{50%} | efficiency | resistance | Density |
| Example 19 | A | Acetylene | 30 | 10 | 2.5 | 1.3 | ⊚ | ⊚ | ⊚ |
| Example 20 | A | Propane | 30 | 10 | 2.5 | 1.3 | ◯ | ⊚ | ⊚ |
| Example 21 | A | Propylene | 30 | 10 | 2.5 | 1.3 | ◯ | ⊚ | ⊚ |
| Example 22 | A | Acetylene | 15 | 10 | 2.5 | 1.3 | ◯ | ⊚ | ⊚ |
| Example 23 | A | Acetylene | 5 | 10 | 2.5 | 1.3 | Δ | ⊚ | ⊚ |
| Example 24 | A | Acetylene | 30 | 0 | 2.5 | 1.3 | ◯ | ⊚ | ⊚ |
| Example 25 | A | Acetylene | 30 | −10 | 2.5 | 1.3 | Δ | ◯ | ◯ |
| Example 26 | A | Acetylene | 30 | 20 | 2.5 | 1.3 | ◯ | ⊚ | ⊚ |
| Example 27 | A | Acetylene | 30 | 30 | 2.5 | 1.3 | Δ | ◯ | ◯ |
| Example 28 | A | Acetylene | 30 | 10 | 0.7 | 1.3 | ◯ | ⊚ | ⊚ |
| Example 29 | A | Acetylene | 30 | 10 | 0.3 | 1.3 | Δ | ⊚ | ⊚ |
| Example 30 | A | Acetylene | 30 | 10 | 0.07 | 1.3 | ▾ | ⊚ | ⊚ |
| Example 31 | A | Acetylene | 30 | 10 | 8 | 1.3 | ◯ | ◯ | ◯ |
| Example 32 | A | Acetylene | 30 | 10 | 20 | 1.3 | Δ | Δ | Δ |
| Example 33 | A | Acetylene | 30 | 10 | 32 | 1.3 | ▾ | ▾ | ▾ |
| Example 34 | A | Acetylene | 30 | 10 | 2.5 | 2.0 | ◯ | ⊚ | ⊚ |
| Example 35 | A | Acetylene | 30 | 10 | 2.5 | 3.1 | Δ | ⊚ | ⊚ |
| Example 36 | A | Acetylene | 30 | 10 | 2.5 | 6.3 | ▾ | ⊚ | ⊚ |
| Comparative | B | None | — | — | 2.5 | 1.4 | X | — | — |
| Example 4 | | | | | | | | | |
| Comparative | C | None | — | — | 2.5 | 1.4 | X | — | — |
| Example 5 | | | | | | | | | |
| Comparative | D | None | — | — | 20 | 1.5 | ⊚ | X | X |
| Example 6 | | | | | | | | | |

As shown in Tables 1 and 2, spray coatings were formed in Examples 1 to 36, which used the high-velocity flame spray gun equipped with the auxiliary fuel feed sections, whereas almost no spray coatings were formed in Comparative Examples 1, 2, 4, and 5, which used the high-velocity flame spray gun not equipped with the auxiliary fuel feed section. The spray coatings obtained in Examples 1 to 36 were higher in density and wear resistance compared with the spray coatings obtained in Comparative Examples 3 and 6, which used the plasma spray gun.

1. A thermal spray gun comprising:
a combustion chamber for generating a flame;
a spray material feed section, which communicates with the combustion chamber, for feeding a spray material to the flame so that the spray material can be softened or melted by the flame;
a discharge port, which communicates with the combustion chamber, for discharging the flame to outside of the thermal spray gun and for jetting out the spray material softened or melted by the flame; wherein a passage is formed from the combustion chamber and through the discharge port; and
an auxiliary fuel feed section, which is disposed in said passage, for feeding an auxiliary fuel to the flame passing through the passage so as to elevate a temperature of the flame.

2. The thermal spray gun according to claim 1, further comprising a spray port disposed in a portion of the passage between the combustion chamber and the spray material feed section,
wherein a cylindrical airflow is sprayed from the spray port, wherein at least a part of the flame generated in the combustion chamber is discharged through the inside of the cylindrical airflow from the discharge port, and wherein the spray material fed from the spray material feed section is softened or melted by the flame inside the cylindrical airflow and is jetted out.

3. The thermal spray gun according to claim 1, wherein the auxiliary fuel feed section is disposed in a portion of the passage between the spray material feed section and the discharge port.

4. The thermal spray gun according to claim 1, wherein the spray material is a ceramic powder.

5. The thermal spray gun according to claim 4, wherein a 50th percentile diameter D_{50%} of the ceramic powder is no more than 25 μm.

6. The thermal spray gun according to claim 4, wherein a value obtained by subtracting a 10th percentile diameter D_{10%} of the ceramic powder from a 90th percentile diameter D₉o% of the ceramic powder and dividing it by a 50th percentile diameter D_{50%} of the ceramic powder is no more than 5.0.

7. The thermal spray gun according to claim 1, wherein the auxiliary fuel feed section feeds the auxiliary fuel at a speed of at least 10 L/min.

8. A thermal spray method using a thermal spray gun, comprising:
a step of generating a flame in a combustion chamber disposed in the thermal spray gun, the generated flame being sent into a passage formed from the combustion chamber and through a discharge port that communicates with the combustion chamber, wherein the flame is then discharged from the discharge port to outside of the thermal spray gun;
a step of feeding a spray material to the flame passing through the passage so that the spray material can be softened or melted by the flame and can be jetted out; and
a step of feeding an auxiliary fuel to the flame passing through the passage to increase a temperature of the flame.

9. The thermal spray method according to claim 8, wherein at least a part of the flame, generated in the combustion chamber, is discharged through the inside of a cylindrical airflow jetted out from the thermal spray gun through the discharge port, and the spray material fed to the flame passing through the passage is softened or melted by the flame inside the cylindrical airflow and is jetted out.

10. The thermal spray method according to claim 8, wherein the auxiliary fuel is fed to the flame passing through the passage, and to which the spray material has been fed.

11. The thermal spray method according to claim 8, wherein the spray material is a ceramic powder.

12. The thermal spray method according to claim 11, wherein a 50% particle diameter D_{50%} of the ceramic powder is no more than 25 μm.

13. The thermal spray method according to claim 11, wherein a value obtained by subtracting a 10th percentile diameter D_{10%} of the ceramic powder from a 90th percentile diameter D_{90%} of the ceramic powder and dividing it by a 50th percentile diameter D_{50%} of the ceramic powder is no more than 5.0.

14. The thermal spray method according to claim 8, wherein a feeding speed of the auxiliary fuel fed to the flame is at least 10 L/min.
